(19) United States
(12) Patent Application Publication
(10) Pub. No.: US 2020/0328665 A1
(43) Pub. Date: Oct. 15, 2020

(54) LINEAR MOTOR STRUCTURE

(71) Applicant: CHIEFTEK PRECISION CO., LTD., TAINAN CITY (TW)

(72) Inventors: MING-CHE HSU, TAINAN CITY (TW); HSUAN-CHUN WU, TAINAN CITY (TW)

(21) Appl. No.: 16/797,433

(22) Filed: Feb. 21, 2020

(30) Foreign Application Priority Data
Apr. 12, 2019 (TW) 108112971

(51) Int. Cl. H02K 41/03; H02K 11/00; H02K 11/33; H02K 33/18

(52) U.S. Cl. CPC H02K 41/031; H02K 33/18; H02K 11/33; H02K 11/0094

(57) ABSTRACT

A linear motor structure includes a stator, at least one moving member, and at least one linear member. The stator extends along an axial direction and has an electromagnetic acting surface. The moving member has an elongated hollow portion passing through the moving member and having a closed annular shape. The stator passes through the elongated hollow portion in the axial direction and is encircled by the moving member. The moving member has an electromagnetic portion relative to the electromagnetic acting surface of the stator. The moving member is electromagnetically reciprocated along the axial direction. The linear member extends along the axial direction. The moving member is coupled to the linear member. Because the moving member is closed and annular, the electromagnetic portion has sufficient supporting rigidity and won't be deformed by the electromagnetic action.

### FIELD OF THE INVENTION

The present invention relates to a linear motor structure, and more particularly to a linear motor having a moving member passing through a closed annular elongated hollow portion, thereby achieving the effect of lightening and thinning the linear motor. Furthermore, the moving member is provided with magnetic members relative to two opposing sides of the stator for increasing the magnetic flux density so as to increase the thrust of the linear motor. Besides, through the feature that the moving member is closed, when the magnetic flux density increases, the rigidity of the moving member is increased to avoid deformation.

### BACKGROUND OF THE INVENTION

A conventional linear motor, as disclosed in Taiwan Patent No. 1647895 titled “LINEAR MOTOR AND CARRIER DEVICE”, is composed of a stator and a moving member. By energizing a coil and a magnetic member to generate an electromagnetic action, the moving member is pushed to reciprocate along the stator. Because the two are operated by the electromagnetic action, the moving member must be closely adjacent to the stator. If a large thrust of the linear motor is required, it is necessary to increase the number of magnetic members for increasing the magnetic flux density. When the electromagnetic action occurs, if the rigidity of the stator or the moving member is insufficient, the stator or the moving member may be deformed by the suction or repulsive force generated by the electromagnetic action.

In addition, automated droppers or pipettes are often used in laboratories, pharmaceutical companies, food plants or other electronic factories for handling the positioning and displacement of tiny electronic components. In use, multiple droppers or pipettes are juxtaposed to suck different solutions or different electronic components. However, the conventional juxtaposed droppers or pipettes are usually operated by a single linear motor, so all the droppers or pipettes are actuated uniformly and cannot be operated alone. With the development of thinned linear motors, each of juxtaposed droppers or pipettes is combined with a single linear motor. U.S. Pat. No. 5,825,104 discloses a “small linear motor table”, comprising a bed and a table. Wherein, the bed is a stator and the table is a moving member. The bed has a certain thickness. The bed is provided with a coil substrate, an armature coil, an insulating sheet, a drive substrate and a drive circuit that are arranged in layers in a thickness direction. The table is provided with a field magnet. A magnetic member, such as a magnet, is disposed on the moving member, so that no moving cable is needed on the moving member. Because the coil substrate, the armature coil, the insulating sheet, the drive substrate and the drive circuit are arranged in layers on the bed, the thickness of the bed is much greater than the thickness of the table. Therefore, the overall volume is still large, which is not adapted for a small working environment. In addition, the moving member (table) does not surround the stator (bed) in a closed manner. In order to form the loop of magnetic lines, the stator must be made of a magnetic material. The stator made of the magnetic material increases the weight and thickness of the linear motor, which is not beneficial to thin the linear motor. In the configuration of the case, only one side of the moving member is provided with the magnetic member, so the magnetic flux density is limited. As a result, the thrust of the linear motor is limited.

In order to detect the moving position of the moving member of the linear motor, a position detector is mounted on the linear motor. For example, U.S. Pat. No. 9,502,953 discloses a “sliding Device”. In this case, an optical scale is disposed on the moving member, and an electronic reading head is fixed on the stator. According to its configuration, the optical scale on the moving member must be in the readable range of the electronic reading head, so the moving distance of the moving member is limited, and the displacement distance is about 2 times the length of the moving member.

### SUMMARY OF THE INVENTION

In order to solve the problem that the stator of the linear motor is large in size, the primary object of the present invention is to provide a linear motor structure, comprising a stator, a frame, at least one moving member, and at least one linear member. The stator is in the form of a plate and extends along an axial direction. The stator has an electromagnetic acting surface. The frame is configured to fix the stator. The moving member has an elongated hollow portion passing through the moving member and having a closed annular shape. The stator passes through the elongated hollow portion in the axial direction and is encircled by the moving member. The moving member has an electromagnetic portion relative to the electromagnetic acting surface of the stator. The moving member is electromagnetically reciprocated along the axial direction. The linear member extends along the axial direction. The moving member is coupled to the linear member.

Preferably, the moving member and the elongated hollow portion have a rectangular shape and include two long sides and two short sides. The electromagnetic acting surface of the stator corresponds to the long sides. The electromagnetic portion is disposed on at least one of the long sides of the elongated hollow portion.

Preferably, the long sides and the short sides have a length ratio of greater than 3.

Preferably, the moving member includes a U-shaped magnetic segment and a flat magnetic segment coupled to the U-shaped magnetic segment. The electromagnetic portion is fixed to a magnet on the U-shaped magnetic segment, or the electromagnetic portion is fixed to magnets on the U-shaped magnetic segment and the flat magnetic segment.

Preferably, the stator has a first side and a second side. The first side and the second side extend along the axial direction and are adjacent to the electromagnetic acting surface. The first side and the second side of the stator correspond to the two short sides of the moving member. The two short sides of the moving member have a working surface relative to the first side and a coupling surface relative to the second side, respectively. The linear member is adjacent to the coupling surface of the moving member. The coupling surface of the moving member is coupled to the linear member.

Preferably, the moving member has another coupling surface relative to the first side of the stator, and another linear member is coupled to the other coupling surface.

Preferably, the linear member includes a slider. The slider has a slide surface parallel to the short sides or the long sides; or the other linear member has another slider, and the other slider has another slide surface parallel to the short sides or the long sides.

Preferably, the stator is a printed circuit board. The printed circuit board is printed with a plurality of coils. The coils form the electromagnetic acting surface.

Preferably, a position feedback circuit is printed on the printed circuit board along the axial direction.

Preferably, the printed circuit board is provided with a drive circuit.

Preferably, the linear motor structure further comprises an elastic member connected to the moving member in the axial direction.

Preferably, the linear motor structure further comprises a longitudinal linear module coupled to the linear member along a longitudinal direction for driving the linear member to move in the longitudinal direction. The longitudinal direction is perpendicular to the axial direction.

Preferably, the frame includes aside plate. The side plate is disposed on at least one of two opposing sides of the stator and the moving member for covering the electromagnetic acting surface of the stator and the electromagnetic portion of the moving member. The side plate is made of a non-magnetic material.

According to the above technical features, the following effects can be achieved:

1. The stator is in the form of a plate. For example, the stator uses a printed circuit board. The coils and other components on the stator are printed on the printed circuit board so as to thin the linear motor.

2. The moving member has a closed annular shape, so that the electromagnetic portion has sufficient supporting rigidity. When the electromagnetic action is generated, the moving member won't be deformed by the electromagnetic action.

3. Because the moving member is closed, the loop of magnetic lines is directly formed on the moving member to reduce the weight and thickness of the linear motor, which is beneficial to thin the linear motor.

4. The moving member may be provided with magnets relative to two sides of the stator, so that the magnetic flux density is increased so as to increase the thrust of the linear motor.

5. By placing the linear member at a position relative to the second side of the stator, the moving member may be narrower relative to the working surface of the first side so as to thin the linear motor of the present invention.

6. Because the linear motor is thinned, a plurality of droppers or pipettes can be closely adjacent to each other and operated individually.

7. The position feedback circuit is printed on the printed circuit board. The position of the moving member is determined by the inductance value, so there is no need for providing a position sensor. When multiple linear motors are required to be combined with multiple droppers or pipettes, there will be no position sensor to hinder the configuration. The position of the moving member is detected by means of the inductance value, which is not subject to the relative position of the optical scale and the electronic reading head, so the moving member may have a longer moving distance.

8. The drive circuit is disposed on the printed circuit board. In use, large electric power (AC current) may be disposed at the far end, thereby improving the safety of use. The electromagnetic field of the large electric power does not interfere with the induction of the position feedback circuit.

9. The moving member is combined with the elastic member, which can prevent the moving member from falling when the power is turned off or provide a buffering effect.

10. The linear member extending axially is attached to the longitudinal linear module extending longitudinally, so that the linear motor can be controlled in two directions.

11. At least one of two opposing sides of the stator and the moving member is covered by the side plate. When multiple linear motors are juxtaposed, the magnetic forces of adjacent linear motors can be prevented from interfering with each other.

### BRIEF DESCRIPTION OF THE DRAWINGS

FIG. 1 is a perspective view of the linear motor of the present invention;

FIG. 2 is a perspective view of a plurality of juxtaposed linear motors combined with droppers in accordance with an embodiment of the present invention:

FIG. 3 is a first schematic view showing a plurality of sets of droppers or pipettes respectively operated by individual linear motors in accordance with an embodiment of the present invention:

FIG. 4 is a second schematic view showing a plurality of sets of droppers or pipettes respectively operated by individual linear motors in accordance with an embodiment of the present invention;

FIG. 5 is a schematic view showing a linear member coupled to either short side of the stator of the linear motor of the present invention:

FIG. 6 is a schematic view showing a linear member coupled to either short side of the stator of the linear motor of the present invention, wherein the coupling direction of the linear member can be changed according to the demand;

FIG. 7 is another schematic view showing a linear member coupled to either short side of the stator of the linear motor of the present invention, wherein the coupling direction of the linear member can be changed according to the demand;

FIG. 8 is a schematic view showing a longitudinal linear module coupled to the axial linear motor of the present invention;

FIG. 9 is a schematic view showing an elastic member coupled to the moving member of the linear motor of the present invention; and

FIG. 10 is a schematic view showing two side plates provided on the frame for covering two opposing sides of the moving member and the stator of the linear motor of the present invention.

### DETAILED DESCRIPTION OF THE PREFERRED EMBODIMENTS

Embodiments of the present invention will now be described, by way of example only, with reference to the accompanying drawings.

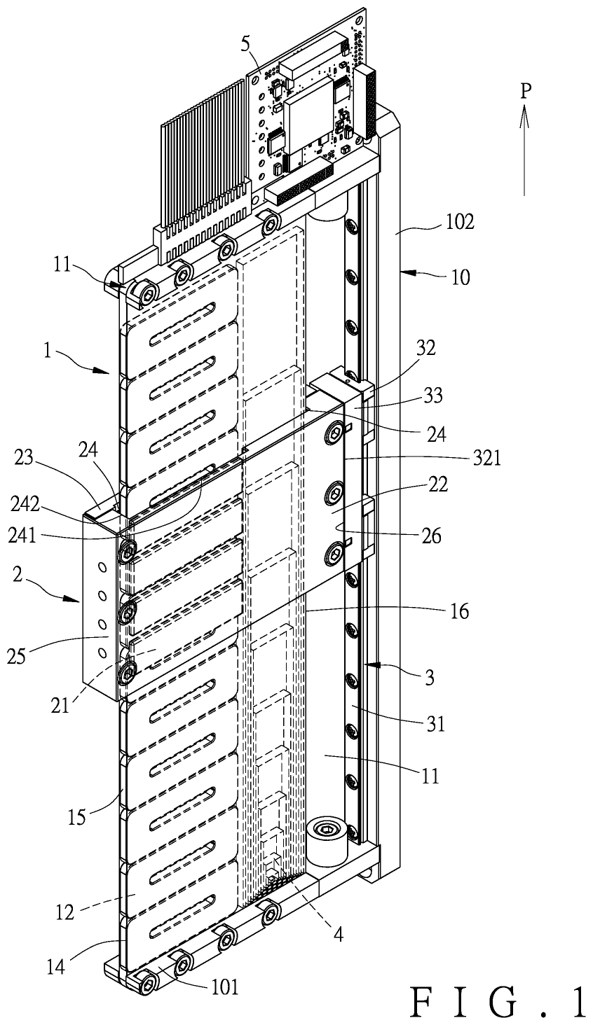

Referring to FIG. 1, a linear motor in accordance with an embodiment of the present invention comprises a stator (1), a moving member (2), a linear member (3), and a frame (10).

The stator (1) extends along an axial direction (P). In this embodiment, the stator (1) is a printed circuit board (11) and is in the form of a plate. The printed circuit board (11) is printed with a plurality of coils (12) arranged along the axial direction (P). The frame (10) is configured to fix the stator (1). The frame (10) is fixed to a worktable. The frame (10) includes two end plates (101) connected to two ends of the printed circuit board (11) and a substrate (102) connected with the two ends plates (101). The coils (12) each have a flat surface as an electromagnetic acting surface (14). The printed circuit board (11) has a first side (15) and a second side (16). The first side (15) and the second side (16) extend along the axial direction (P) and are adjacent to the electromagnetic acting surface (14). The moving member (2) has an elongated hollow portion (24) passing through the moving member (2) and having a closed annular shape. The stator (1) passes through the elongated hollow portion (24) in the axial direction (P) and is encircled by the moving member (2). The moving member (2) has an electromagnetic portion (21) relative to the electromagnetic acting surface (14). The moving member (2) is electromagnetically reciprocated along the axial direction (P). The moving member (2) and the elongated hollow portion (24) have a rectangular shape and include two long sides (241) and two short sides (242). The length ratio of the long sides (241) and the short sides (242) is greater than 3. The electromagnetic acting surface (14) of the stator (1) corresponds to the long sides (241). The electromagnetic portion (21) is disposed on at least one of the long sides (241) of the elongated hollow portion (24). In this embodiment, the moving member (2) comprises a U-shaped magnetic segment (22) and a flat magnetic segment (23) coupled to the U-shaped magnetic segment (22). The electromagnetic portion (21) is fixed to the U-shaped magnetic segment (22) and located in the elongated hollow portion (24). The electromagnetic portion (21) is a magnet. In order to increase the thrust of the linear motor, the electromagnetic portion (21) may be disposed on both the U-shaped magnetic segment (22) and the flat magnetic segment (23) to increase the magnetic flux density. The first side (15) and the second side (16) of the stator (1) correspond to the two short sides (242) of the moving member (2). The moving member (2) has a working surface (25) relative to the first side (15) and a coupling surface (26) relative to the second side (16). The linear member (3) extends along the axial direction (P), and the linear member (3) is adjacent to the coupling surface (26) of the moving member (2). The linear member (3) may be a linear slide rail or a bearing or a ball screw. A linear slide rail is taken as an example, including a slide rail (31), two sliders (32), and a carrier (33). The slide rail (31) is fixed to the substrate (102) of the frame (10). The slider (32) straddles the slide rail (31). The carrier (33) is fixed to the slider (32). The coupling surface (26) of the moving member (2) is coupled to the carrier (33). In this embodiment, the slider (32) has a slide surface (321) parallel to the short side (242). With this configuration, because the moving member (2) is closed and annular, the loop of magnetic lines is directly formed on the moving member (2) to reduce the weight and thickness of the linear motor, which is beneficial to thin the linear motor. Besides, the electromagnetic portion (21) has sufficient supporting rigidity. When the electromagnetic action is generated, the moving member (2) won't be deformed by the electromagnetic action. By placing the linear member (3) at a position relative to the second side (16) of the stator (1), the moving member (2) may be narrower relative to the working surface (25) of the first side (15) so as to thin the linear motor.

In this embodiment, a position feedback circuit (4) is printed on the printed circuit board (11) of the stator (1) along the axial direction (P). One end of the printed circuit board (11) is provided with a drive circuit (5).

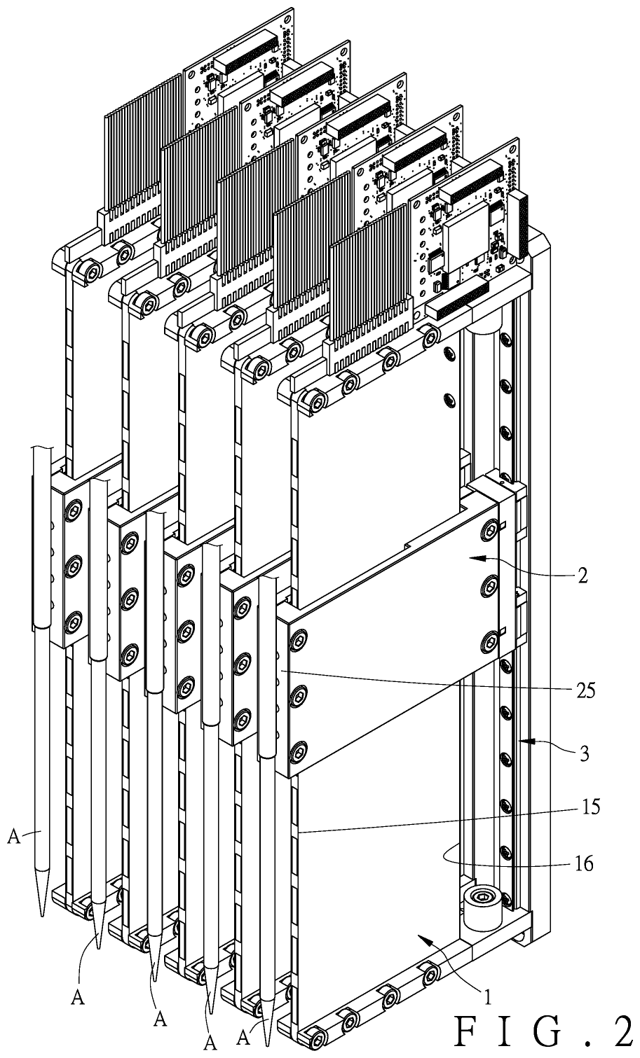

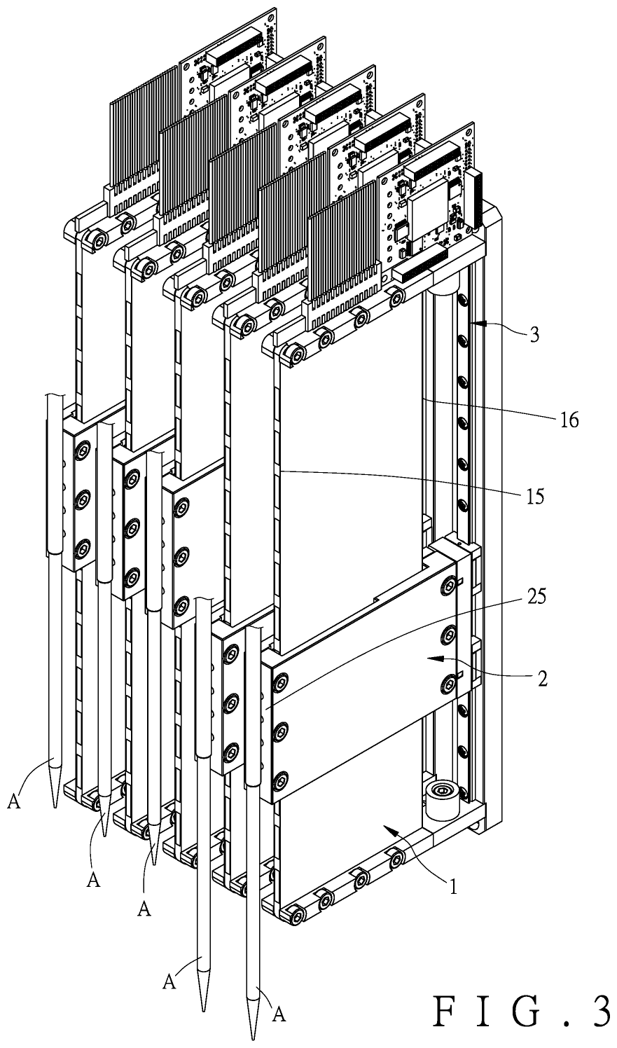

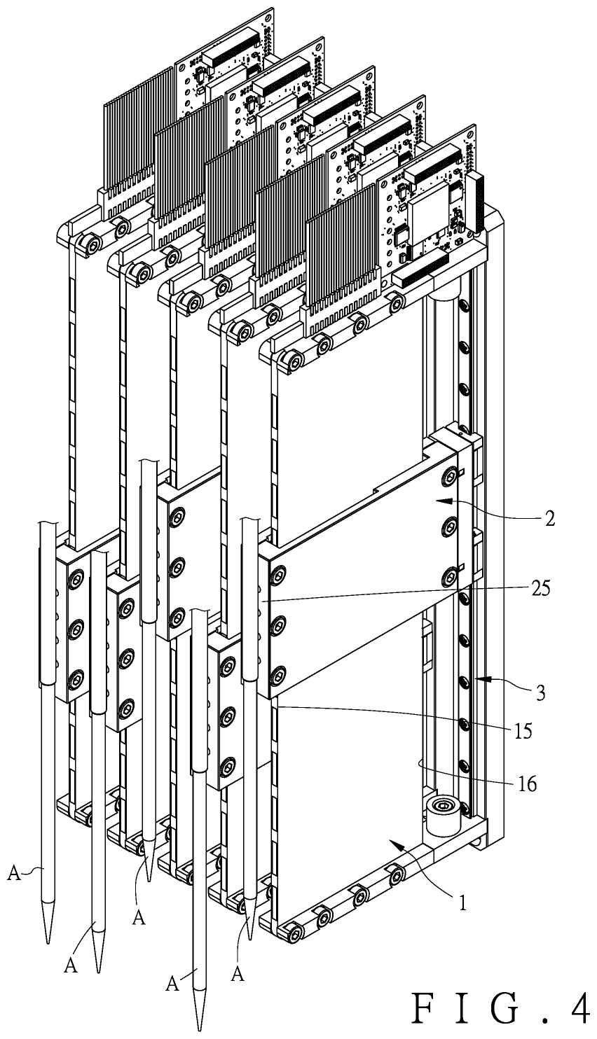

As shown in FIG. 2 through FIG. 4, in use, multiple droppers (A) are coupled to the working surface (25) of the moving member (2). Because the linear member (3) is disposed at a position relative to the second side (16) of the stator (1), the moving member (2) may be narrower relative to the working surface (25) of the first side (15). Therefore, the droppers (A) can be closely arranged to meet the needs of the machine. Each of the droppers (A) is controlled by a linear motor, so that the droppers (A) can be operated separately. In addition, the position feedback circuit (4) (referring to FIG. 1) is printed on the printed circuit board (11). The position of the moving member (2) is determined by the inductance value, so there is no need for providing a position sensor. When multiple linear motors are required to be combined with multiple droppers (A), there will be no position sensor to hinder the configuration. The position of the moving member (2) is detected by means of the inductance value, which is not subject to the relative position of the optical scale and the electronic reading head so that the moving member (2) may have a longer moving distance. The drive circuit (5) is disposed on the printed circuit board (11). In use, the large electric power (AC current) may be disposed at the far end, thereby improving the safety of use. The electromagnetic field of the large electric power does not interfere with the induction of the inductance of the position feedback circuit (4).

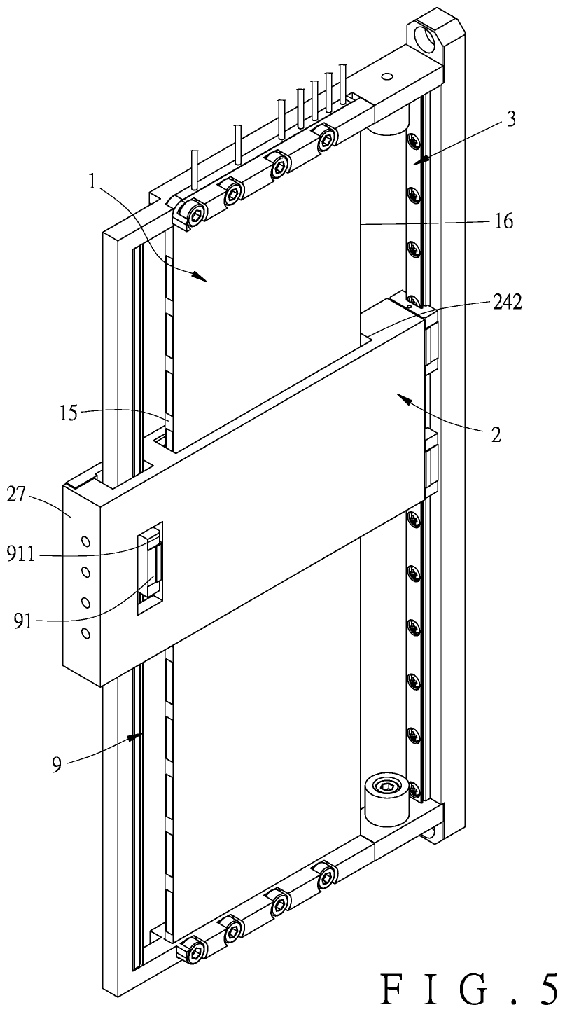

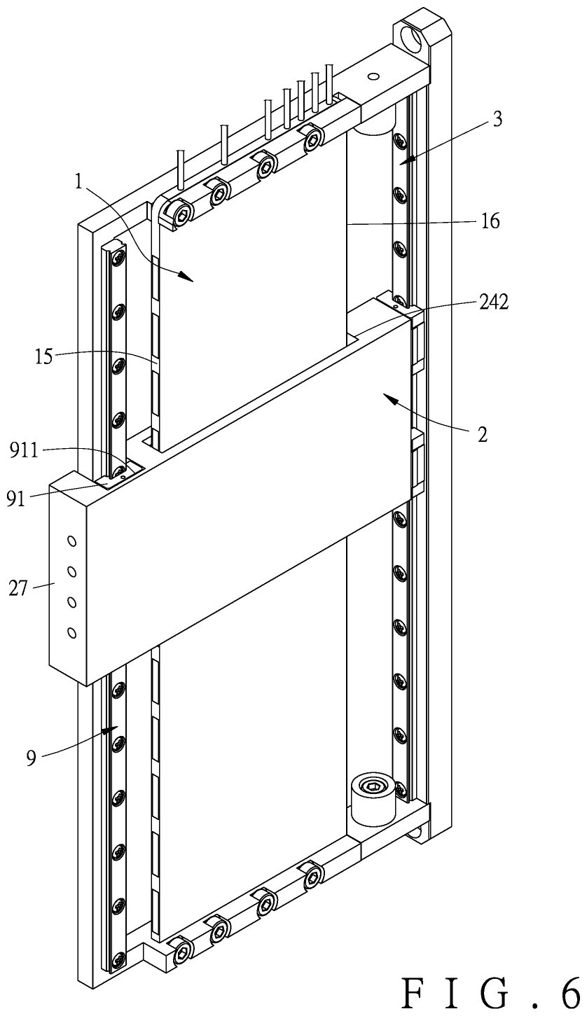

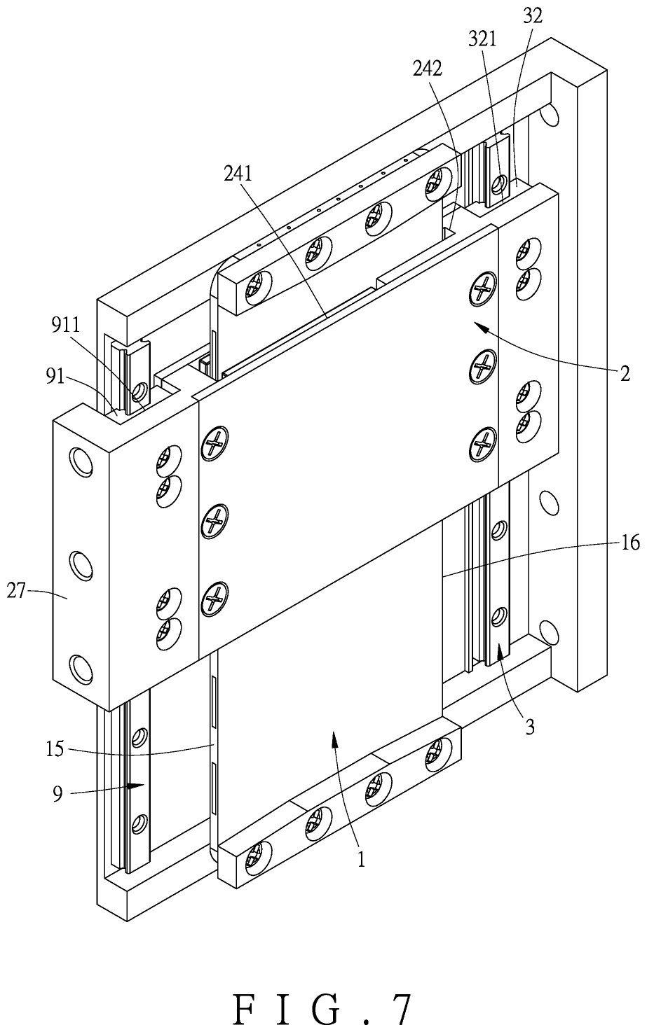

Referring to FIG. 5 through FIG. 7, sometimes the linear motor needs to load a workpiece that is heavier and less likely to be driven by a single linear member, in addition to the linear member (3) disposed on the short side (242) of the moving member (2) relative to the second side (16) of the stator (1), the moving member (2) has another coupling surface (27) relative to the first side (15) of the stator (1), and another linear member (9) is coupled to the other coupling surface (27). The linear member (9) has another slider (91). The slider (91) has another slide surface (911) parallel to the short side (242) or the long side (241), or both the slide surface (321) of the slider (32) of the linear member (3) and the slide surface (911) of the slider (91) of the linear member (9) are parallel to the long side (241). The coupling directions of the linear member (3) and the linear member (9) can be changed as needed. With this configuration, the linear slide can carry a heavier workpiece.

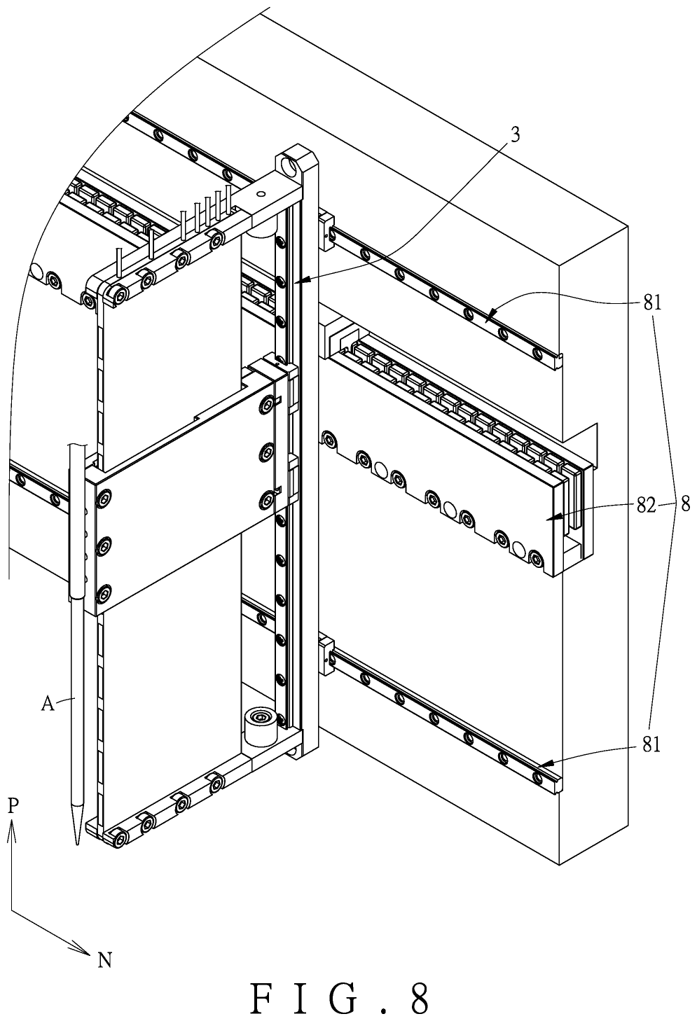

Referring to FIG. 8, the present invention further comprises a longitudinal linear module (8) coupled to the linear member (3) along a longitudinal direction (N). The longitudinal linear module (8) has a linear member (81) coupled to the upper and lower ends of the linear member (3) and a linear motor (82) disposed at the middle portion of the linear member (3) for driving. Thereby, the linear member (3) is driven by the longitudinal linear module (8) to move in the longitudinal direction (N). The longitudinal direction (N) is perpendicular to the axial direction (P), so that the droppers (A) can be controlled in two directions.

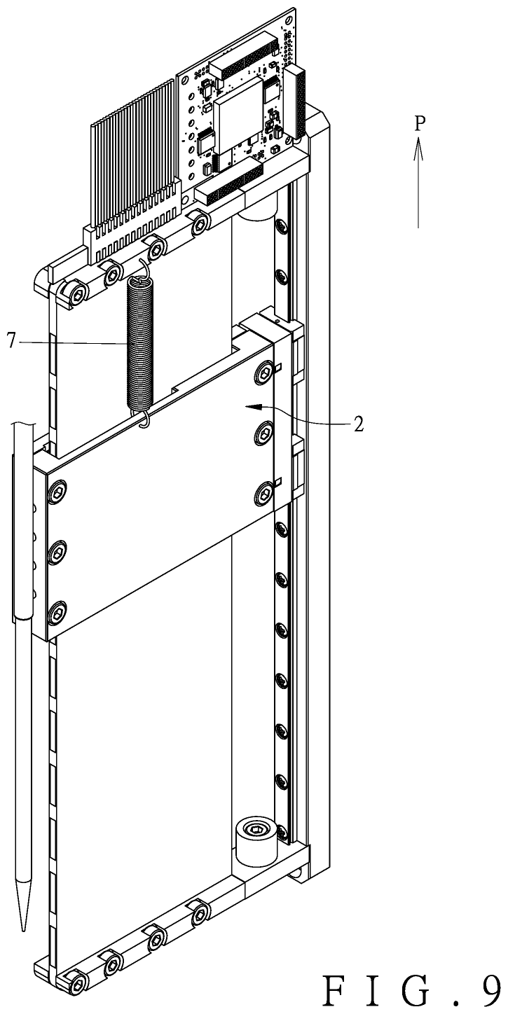

Referring to FIG. 9, because the linear motor of the present invention belongs to a miniaturized linear motor, its moving member (2) has a limited loading capacity. When the attached droppers (A) are combined with other components, or they are heavy due to the factor of its material or the moving member (2) is used to load other heavier workpieces, an elastic member (7) is connected to the moving member (2) in the axial direction (P). Through the elastic force of the elastic member (7), the loading capacity of the moving member (2) is increased, or a buffering effect is achieved, or it is possible to prevent the moving member (2) from falling when the power is turned off.

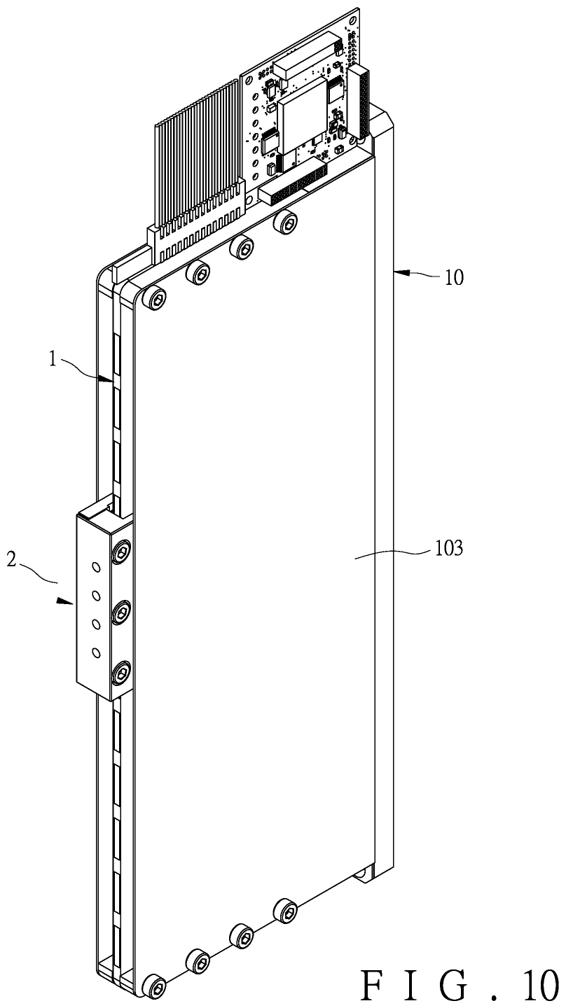

Referring to FIG. 10, when a plurality of linear motors are juxtaposed, in order to prevent the magnetic forces of adjacent linear motors from interfering with each other, the frame (10) used for combining the stator (1) with the moving member (2) may be provided with a side plate (103). The side plate (103) may be disposed on one side or both sides of the frame (10). In the embodiment of FIG. 10, the side plate (103) is disposed on both sides of the frame (10), that is, two side plates (103) are located at two opposing sides of the stator (1) and the moving member (2) for covering the electromagnetic acting surface (14) of the stator (1) and the electromagnetic portion (21) of the moving member (2). As to the electromagnetic acting surface (14) and the electromagnetic portion (21), please refer to FIG. 1. The two side plates (103) are made of a non-magnetic material to prevent the magnetic forces of adjacent linear motors from interfering with each other.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A linear motor structure, comprising:
a stator, in the form of a plate, extending along an axial direction, the stator having an electromagnetic acting surface;
a frame, configured to fix the stator;
at least one moving member, having an elongated hollow portion passing through the moving member and having a closed annular shape, the stator passing through the elongated hollow portion in the axial direction and being encircled by the moving member, the moving member having an electromagnetic portion relative to the electromagnetic acting surface of the stator, the moving member being electromagnetically reciprocated along the axial direction;
at least one linear member, extending along the axial direction, the moving member being coupled to the linear member.

2. The linear motor structure as claimed in claim 1, wherein the moving member and the elongated hollow portion have a rectangular shape and include two long sides and two short sides, the electromagnetic acting surface of the stator corresponds to the long sides, and the electromagnetic portion is disposed on at least one of the long sides of the elongated hollow portion.

3. The linear motor structure as claimed in claim 2, wherein the long sides and the short sides have a length ratio of greater than 3.

4. The linear motor structure as claimed in claim 2, wherein the moving member includes a U-shaped magnetic segment and a flat magnetic segment coupled to the U-shaped magnetic segment, the electromagnetic portion is fixed to a magnet on the U-shaped magnetic segment, or the electromagnetic portion is fixed to magnets on the U-shaped magnetic segment and the flat magnetic segment.

5. The linear motor structure as claimed in claim 2, wherein the stator has a first side and a second side, the first side and the second side extend along the axial direction and are adjacent to the electromagnetic acting surface, the first side and the second side of the stator correspond to the two short sides of the moving member, the two short sides of the moving member have a working surface relative to the first side and a coupling surface relative to the second side respectively, the linear member is adjacent to the coupling surface of the moving member, and the coupling surface of the moving member is coupled to the linear member.

6. The linear motor structure as claimed in claim 5, wherein the moving member has another coupling surface relative to the first side of the stator, and another linear member is coupled to the other coupling surface.

7. The linear motor structure as claimed in claim 6, wherein the linear member includes a slider, the slider has a slide surface parallel to the short sides or the long sides; or the other linear member has another slider, and the other slider has another slide surface parallel to the short sides or the long sides.

8. The linear motor structure as claimed in claim 1, wherein the stator is a printed circuit board, the printed circuit board is printed with a plurality of coils, and the coils form the electromagnetic acting surface.

9. The linear motor structure as claimed in claim 8, wherein a position feedback circuit is printed on the printed circuit board along the axial direction.

10. The linear motor structure as claimed in claim 8, wherein the printed circuit board is provided with a drive circuit.

11. The linear motor structure as claimed in claim 1, further comprising an elastic member connected to the moving member in the axial direction.

12. The linear motor structure as claimed in claim 1, further comprising a longitudinal linear module coupled to the linear member along a longitudinal direction for driving the linear member to move in the longitudinal direction, the longitudinal direction being perpendicular to the axial direction.

13. The linear motor structure as claimed in claim 1, wherein the frame includes a side plate, the side plate is disposed on at least one of two opposing sides of the stator and the moving member for covering the electromagnetic acting surface of the stator and the electromagnetic portion of the moving member, and the side plate is made of a non-magnetic material.
